(19) United States
(12) Patent Application Publication
(10) Pub. No.: US 2022/0025551 A1
(43) Pub. Date: Jan. 27, 2022

(54) METHOD OF FORMING FIBER-SHAPED STRUCTURE, FIBER-SHAPED STRUCTURE, AND DEVICE HAVING THE FIBER-SHAPED STRUCTURE

(71) Applicant: Nanyang Technological University, Singapore (SG)

(72) Inventors: Lei Wei, Singapore (SG); Zhixun Wang, Singapore (SG); Zhe Wang, Singapore (SG)

(21) Appl. No.: 17/285,036

(22) PCT Filed: Aug. 30, 2019
(86) PCT No.: PCT/SG2019/050431

§ 371 Date: Apr. 13, 2021

(51) Int. Cl. D01D 5/34; B29C 51/00; H01B 1/14; H01B 1/20; H01B 7/00; H01B 7/02; C03B 37/03

(52) U.S. Cl. CPC D01D 5/34; B29C 51/002; H01B 1/14; C03B 37/03; H01B 7/0009; H01B 7/02; H01B 1/20

(57) ABSTRACT

According to embodiments of the present invention, a method of forming a fiber-shaped structure is provided. The method includes subjecting a precursor material arrangement to a thermal drawing process to form the fiber-shaped structure, the precursor material arrangement including a preform of a first material having a first melting point, and a second material in an interior space of the preform, the second material having a second melting point that is higher than the first melting point, wherein the thermal drawing process includes subjecting the preform and the second material to a heating process to heat the preform to a molten state for forming the fiber-shaped structure, wherein the second material that is heated remains in a solid state, and wherein the fiber-shaped structure that is formed includes the first material and the second material.

### CROSS-REFERENCE TO RELATED APPLICATION

This application claims the benefit of priority of Singapore patent application No. 10201809239U, filed 19 Oct. 2018, the content of it being hereby incorporated by reference in its entirety for all purposes.

### TECHNICAL FIELD

Various embodiments relate to a method of forming a fiber-shaped structure, a fiber-shaped structure obtained by the method, and a device having the fiber-shaped structure.

### BACKGROUND

Fiber, as a natural form of materials, plays an important role in a wide range of applications, including communications, remote sensing, energy harvesting, etc. To realise sophisticated functionalities and improve the performance, multi-materials fiber is thus needed. By incorporating different materials, the electronic, mechanical, thermal or optical properties of a single fiber can be tuned.

Thermal fiber drawing technique is used for large-scale fiber fabrication. It starts with a macrostructured preform and it is drawn into a microfiber while being heated. To successfully realise the drawing process, all materials used in the preform have to own similar melting points. Thus, it fundamentally limits the selection of materials that can be integrated in a single fiber. For example, materials with high melting point can only be drawn with silica preform using traditional thermal fiber drawing technique, while both the flexibility and geometry of resulting fiber are limited. To address this limitation, several approaches have been developed. The most direct one is polymer coating, but it is restricted from forming complex geometries. Another method is to deposit materials onto the inner/outer surface of the after-drawn fiber. However, it needs high-precision process control which leads to a high cost and low production yield. Also, the resulting fiber suffers from poor uniformity on microstructure. The in-situ synthesis method is also developed. It utilises fiber as a crucible and synthesises high melting point materials as the drawing process proceeds. This method is ingenious but also has the limitations on materials, and a proper chemical reaction must be chosen carefully. It is challenging to address the limitations without sacrificing the geometric complexity.

### SUMMARY

The invention is defined in the independent claims. Further embodiments of the invention are defined in the dependent claims.

According to an embodiment, a method of forming a fiber-shaped structure is provided. The method may include subjecting a precursor material arrangement to a thermal drawing process to form the fiber-shaped structure, the precursor material arrangement including a preform of a first material having a first melting point, and a second material in an interior space of the preform, the second material having a second melting point that is higher than the first melting point, wherein the thermal drawing process includes subjecting the preform and the second material to a heating process to heat the preform to a molten state for forming the fiber-shaped structure, wherein the second material that is heated remains in a solid state, and wherein the fiber-shaped structure that is formed includes the first material and the second material.

According to an embodiment, a fiber-shaped structure obtained by the method disclosed herein is provided.

According to an embodiment, a device having the fiber-shaped structure disclosed herein is provided.

### BRIEF DESCRIPTION OF THE DRAWINGS

In the drawings, like reference characters generally refer to like parts throughout the different views. The drawings are not necessarily to scale, emphasis instead generally being placed upon illustrating the principles of the invention. In the following description, various embodiments of the invention are described with reference to the following drawings, in which:

FIG. 1 shows a method of forming a fiber-shaped structure, according to various embodiments.

FIG. 2A shows a schematic diagram illustrating thermal drawing with incorporation of a wire made of a high melting point material, according to various embodiments.

FIG. 2B shows an optical microscope image of a cross-section of a resulting fiber with a silica core and a polycarbonate (PC) cladding, FIG. 2C shows a scanning electron microscope (SEM) image of a cross-section of an obtained fiber with a copper core and a polycarbonate (PC) cladding, and FIG. 2D shows a scanning electron microscope (SEM) image of a cross-section of an obtained fiber with a nickel chromium alloy core and a polycarbonate (PC) cladding.

FIG. 3A shows a schematic diagram illustrating a photodetector fiber, while FIG. 3B shows a schematic cross-sectional view of a preform for fabricating the fiber of FIG. 3A.

FIGS. 4A to 4C show examples of fibers of different structures, according to various embodiments.

FIG. 5A shows an optical microscope image illustrating a side view of a fiber with two metal wires.

FIG. 5B shows a schematic view of a fiber with conductive wires, with a portion of the fiber cut away to show the interior of the fiber.

FIG. 5C shows a plot of output voltage of fiber-shaped batteries.

FIG. 5D shows a photograph illustrating demonstration of a wearable fabric with fiber-shaped rechargeable batteries.

FIG. 6A shows a schematic diagram illustrating thermal drawing of a fiber using a preform design with a geometry having two polymer electrodes, and a semiconductor wire, while FIG. 6B shows an optical image of a used preform and the resulting fiber.

FIG. 7 shows an optical microscope image and two scanning electron microscope (SEM) images of a fiber fabricated based on the thermal drawing process of FIG. 6A.

FIG. 8 shows a current-voltage plot corresponding to the fiber of FIG. 7.

FIG. 9A shows a schematic view of a precursor material arrangement for a fiber-based battery, while FIG. 9B shows an optical microscope image of part of a fabricated fiber-based battery.

FIGS. 10A and 10B show schematic cross-sectional views respectively of a preform for a fiber-based FET (field effect transistor) and a fabricated fiber-based FET.

FIG. 11 shows a schematic cross-sectional view of a precursor material arrangement, according to various embodiments.

FIGS. 12A and 12B show schematic cross-sectional views of precursor material arrangements and fiber-shaped structures illustrating arrangement of two wires in a concentric manner, according to various embodiments.

FIG. 13 shows a schematic diagram illustrating thermal drawing with incorporation of particles.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the methods or devices are analogously valid for the other methods or devices. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the phrase “at least substantially” may include “exactly” and a reasonable variance.

In the context of various embodiments, the term “about” or “approximately” as applied to a numeric value encompasses the exact value and a reasonable variance.

As used herein, the term “and/or” includes any and all combinations of one or more of the associated listed items.

As used herein, the phrase of the form of “at least one of A or B” may include A or B or both A and B. Correspondingly, the phrase of the form of “at least one of A or B or C”, or including further listed items, may include any and all combinations of one or more of the associated listed items.

Various embodiments may provide convergence methods for fabricating multi-material fibers, and thermal drawn multi-material fibers based on the convergence methods.

Various embodiments may provide a fabrication method called a convergence method. It is based on direct thermal drawing. The method allows drawing of fibers with materials considered ‘incompatible’ for known thermal drawing techniques. In the convergence method, a scale-down in dimensions of preform may be used as a convergence process, to achieve an intimate contact between one or more low melting point materials and one or more high melting point materials. Since the high melting point material(s) stays at solid state during the whole process, the shape of the high melting point material(s) remains unchanged and the interfaces are sharp and clear. Potential oxidation may thus be minimised or eliminated. Also, complex geometries may be realised by certain preform designs.

In one non-limiting example, a method of fabricating a multi-material fiber may be provided, including providing at least one wire (or fiber) having a first melting point, providing a preform having a second melting point, and feeding the wire into the preform during a thermal drawing process, wherein the first melting point is higher than the second melting point such that the wire remains in solid state during the thermal drawing process.

In one embodiment, the wire may have a fiber form. The wire may form a core of the multi-material fiber and the preform material may form the cladding of the multi-material fiber.

When two or more wires are used in the method, the two or more wires may have the same or similar melting points. The two or more wires may have different melting points which are higher than the melting point of the preform.

The methods of various embodiments may offer one or more of the following features, compared to known technologies: (i) a scalable and one step fabrication method to produce multi-material fibers beyond the limitation of sets of materials that are required to be compatible to one another that are associated with known thermal drawing processes, with no compromise on geometric complexity, (ii) the contact between high melting point material(s) and low melting point material(s) is intimate, and the interface is sharp and clear, (iii) potential oxidation is minimised or avoided.

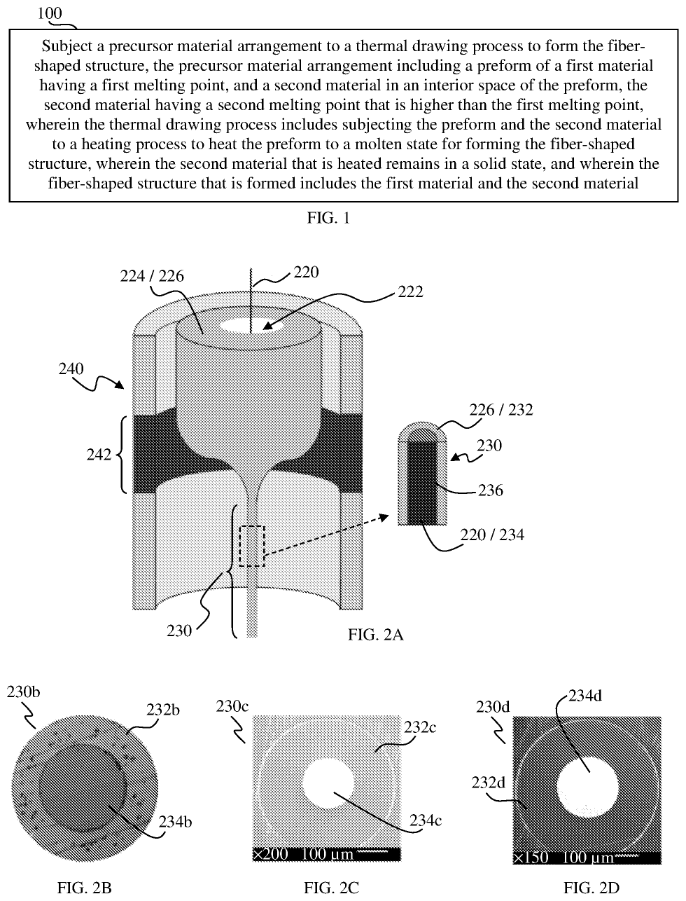

FIG. 1 shows a method of forming a fiber-shaped structure, according to various embodiments. At 100, a precursor material arrangement is subjected to a thermal drawing process to form the fiber-shaped structure, the precursor material arrangement including a preform of a first material having a first melting point, and a second material in an interior space of the preform, the second material having a second melting point that is higher than the first melting point, wherein the thermal drawing process includes subjecting the preform and the second material to a heating process to heat the preform to a molten state for forming the fiber-shaped structure, wherein the second material that is heated remains in a solid state, and wherein fiber-shaped structure that is formed includes the first material and the second material.

The term “precursor material arrangement” may mean an arrangement of starting materials or structures for forming the fiber-shaped structure, or to be thermally drawn into the fiber-shaped structure.

In the context of various embodiments, the precursor material arrangement includes solid materials for the thermal drawing process. The preform is in solid form, meaning that the first material is in solid form. The second material in the precursor material arrangement is in solid form.

The preform and the second material may or may not be in contact with each other in the precursor material arrangement. In various embodiments, the second material of the precursor material arrangement may be in contact with the preform prior to and during the heating process.

The interior space of the preform may be a hollow channel or a cavity. The second material may be centrally located in the interior space.

The term “melting point” in relation to a solid refers to the temperature at which the solid melts.

The first material may be a low melting point material, or at least a material having a lower melting point relative to the second material. The second material may be a high melting point material, or at least a material having a higher melting point relative to the first material.

During the thermal drawing process, the preform and the second material may be subjected to the heating process, for example, at a temperature that is equal to or more than the first melting point, meaning that the thermal drawing temperature is, at the minimum, at least substantially equal to the first melting point. It should be appreciated that the heating process may be performed at any temperature that is equal to or more than the first melting point and less than the second melting point. The preform and the second material may be heated at a temperature that is sufficiently away or less than the second melting point.

During the heating process, the preform is heated to a molten state for drawing of the first material and the second material into the fiber-shaped structure. In other words, as a result of the heating process, the first material is heated to the molten state, and may be drawn together with the second material to form the fiber-shaped structure during the thermal drawing process.

During the heating process, the part of the second material that is subjected to heat remains a solid, meaning that it is not melted or not heated to a molten state during the thermal drawing process.

In the context of various embodiments, the second melting point of the second material may be in a range of between about 200° C. and about 5000° C., for example, between about 200° C. and about 4000° C., between about 200° C. and about 3000° C., between about 200° C. and about 2000° C., between about 200° C. and about 1000° C., between about 1000° C. and about 5000° C., between about 2000° C. and about 5000° C., between about 3000° C. and about 5000° C., between about 4000° C. and about 5000° C., or between about 2000° C. and about 4000° C. As non-limiting examples, the second material may be carbon having a melting point of about 3700° C., or tantalum hafnium carbide having a melting point of about 4100° C. However, it should be appreciated that the second material that is used may even have a melting point that is higher than 5000° C., for example, depending on the applications.

In the context of various embodiments, a difference between the second melting point and the first melting point may be in a range of between about 50° C. and about 5000° C., for example, between about 50° C. and about 4000° C., between about 50° C. and about 3000° C., between about 50° C. and about 2000° C., between about 50° C. and about 1000° C., between about 500° C. and about 5000° C., between about 1000° C. and about 5000° C., between about 2000° C. and about 5000° C., between about 3000° C. and about 5000° C., between about 4000° C. and about 5000° C., or between about 500° C. and about 1000° C.

The resulting fiber-shaped structure has the same materials as those of the precursor material arrangement, i.e., having the first material and the second material. The shape of the resulting fiber-shaped structure generally follows the shape of the preform. The shape of the second material in the fiber-shaped structure follows the shape of the second material of the precursor material arrangement.

The first material and the second material are in contact with each other in the fiber-shaped structure. The interface between the first material and the second material in the fiber-shaped structure is sharp and well-defined as a result of the second material remaining in a solid state during the thermal drawing process.

The fabricated fiber-shaped structure may have a core-cladding structure, with the first material in the cladding, and the second material in the core region.

In the context of various embodiments, the precursor material arrangement is a multi-material precursor arrangement. As a result, the fiber-shaped structure is a multi-material fiber-shaped structure.

The method may further include feeding the second material into the interior space of the preform during the thermal drawing process, e.g., the second material may be continuously fed into the interior space.

In various embodiments, the second material of the precursor material arrangement may be in an elongate shape, e.g., in the form of a wire, a fiber, a rod, a tube, etc.

In various embodiments, the second material of the precursor material arrangement may be in a particulate form. This may mean that the precursor material arrangement may include one or more particles of the second material in the interior space of the preform. The particle(s) may include at least one of glass, semiconductor, or metal.

In the context of various embodiments, the second material may include at least one of a metal (e.g., copper (Cu), silver (Ag), zinc (Zn)), an alloy (e.g., nickel chromium), a semiconductor (e.g., silicon (Si), germanium (Ge)), a ceramic, a carbon-based material or a glass (e.g., silica). The semiconductor may be doped semiconductor, e.g., n-doped or p-doped.

In the context of various embodiments, the first material may include at least one of a glass or a thermoplastic polymer (e.g., polycarbonate (PC), polyetherimide (PEI)).

In various embodiments, the preform may further include a (electrically) conductive material (e.g., conductive polyethylene (CPE)). The conductive material may be subjected to the heating process for forming the fiber-shaped structure, and the fiber-shaped structure that is formed may further include the conductive material. Therefore, the conductive material may be drawn, together with the first and second materials, into the fiber-shaped structure. During the heating process, the conductive material may be heated to a molten state for drawing of the first material, the second material and the conductive material into the fiber-shaped structure. In other words, as a result of the heating process, the first material and the conductive material are heated to the molten state, and may be drawn together with the second material to form the fiber-shaped structure during the thermal drawing process. The conductive material may be for electrical coupling with the second material in the fiber-shaped structure. In the fiber-shaped structure, the conductive material may be electrically coupled to or in contact with the second material. The conductive material in the fiber-shaped structure may act or define one or more electrodes.

In various embodiments, the preform may further include a photonic bandgap (PBG) structure. The PBG structure may be subjected to the heating process for forming the fiber-shaped structure, and the fiber-shaped structure that is formed may further include the PBG structure. Therefore, the PBG structure may be drawn, together with the first and second materials, into the fiber-shaped structure.

In various embodiments, the second material may include a (electrically) conductive material.

In various embodiments, the precursor material arrangement may further include a third material in the interior space of the preform, the third material having a third melting point that is higher than the first melting point, wherein the thermal drawing process may further include subjecting the third material to the heating process for forming the fiber-shaped structure, wherein the third material that is heated remains in a solid state, and wherein the fiber-shaped structure that is formed may further include the third material. The third material in the precursor material arrangement is in solid form.

The method may further include feeding the third material into the interior space of the preform during the thermal drawing process, e.g., the third material may be continuously fed into the interior space.

The preform and the third material may or may not be in contact with each other in the precursor material arrangement. In various embodiments, the third material of the precursor material arrangement may be in contact with the preform prior to and during the heating process.

The third material may be a high melting point material, or at least a material having a higher melting point relative to the first material.

During the heating process, the third material is heated with the preform and the second material. The part of the third material that is subjected to heat remains a solid, meaning that it is not melted or not heated to a molten state during the thermal drawing process. The preform, the second material and the third material may be heated at a temperature that is sufficiently away or less than the second melting point and the third melting point.

The first material and the third material are in contact with each other in the fiber-shaped structure. The interface between the first material and the third material in the fiber-shaped structure is sharp and well-defined as a result of the third material remaining in a solid state during the thermal drawing process.

The fabricated fiber-shaped structure may have a core-cladding structure, with the first material in the cladding, and the second and third materials defining the core region or separate core regions.

In the precursor material arrangement, the second material and the third material may be adjacent to each other, or located side-by-side to each other.

In the context of various embodiments, the third material may include at least one of a metal (e.g., copper (Cu), silver (Ag), zinc (Zn)), an alloy (e.g., nickel chromium), a semiconductor (e.g., silicon (Si), germanium (Ge)), a ceramic, a carbon-based material or a glass (e.g., silica). The semiconductor may be doped semiconductor, e.g., n-doped or p-doped.

In various embodiments, the third material may include a (electrically) conductive material.

In various embodiments, the second melting point and the third melting point may be at least substantially the same, meaning that the second and third materials may melt at about the same temperature.

In various embodiments, the second melting point and the third melting point may be different melting points.

In various embodiments, the third material of the precursor material arrangement may be in an elongate shape (e.g., in the form of a wire, a fiber, a rod, a tube, etc.), or in a particulate form (e.g., one or more particles, e.g., of at least one of glass, semiconductor, or metal).

The second and third materials may be of the same shape, or of different shapes or forms.

In the context of various embodiments, the preform may be of any suitable shape (e.g., circular, rectangular, etc.) or designed to have a particular geometry or configuration. Such shape, geometry or configuration is imparted to the resulting fiber-shaped structure.

In the context of various embodiments, the method may be known as a convergence method.

Non-limiting examples of combination of first-second materials may include but not limited to PC-silica, PC-copper, PC-nickel chromium alloy, PC-silicon

Various embodiments may further provide a fiber-shaped structure obtained by the method described herein. The obtained fiber-shaped structure may have one or more properties or characteristics, for example, in terms of material, geometry, etc. as described in the context of the method of FIG. 1.

The fiber-shaped structure has an immiscible interface between the first material and the second material, meaning that there is no interdiffusion or mixing of the first and second materials at the interface as a result of the second material remaining in a solid state during the thermal drawing process. The interface between the first and second materials is well-defined and sharp, as defined by the outer boundary or perimeter of the second material.

In other words, there may be provided a fiber-shaped structure including a first material having a first melting point, and a second material at least substantially surrounded by the first material, the second material having a second melting point that is higher than the first melting point, wherein an immiscible interface between the first material and the second material is defined in the fiber-shaped structure. The first material may define the cladding region (or outer region) of the fiber-shaped structure. The second material may define the core region (or inner region) of the fiber-shaped structure.

The fiber-shaped structure may be or may include at least one of an optical device (e.g., an optical fiber), an electrical device (e.g., an electrical conductor, a storage device, a transistor), or a mechanical device. The term “electrical device” also refers to an electronic device.

In various embodiments, the fiber-shaped structure may be or may include an electrical device further having an electrolyte. The fiber-shaped structure including the electrolyte may be a battery.

In various embodiments, the fiber-shaped structure may be flexible.

Various embodiments may further provide a device or system including the fiber-shaped structure described herein. The device may be an electronic device (e.g., wearable electronics), a sensor (e.g., optical sensor), etc.

Various embodiments will now be described in further detail, with reference to the drawings.

In the techniques disclosed herein, high melting point materials, including but not limited to metals, semiconductors, ceramics, carbon-based materials, and glasses may be used in fiber form and fed into the preform during the thermal drawing process. The preform may be fabricated with a low temperature material including but not limited to glasses or thermoplastic polymer such as polycarbonates (PC) and polyetherimide (PEI) which have a low melting point (usually lower than 573K). The preform may be pre-designed with a specific structure, for example, to achieve a complex geometry or to realise a certain functionality in the after-drawn fiber structure.

Using a core-cladding structure as a non-limiting example, the schematic illustrating the method of various embodiments is shown in FIG. 2A. In a thermal drawing process, a wire 220 of a high(er) melting point material may be fed into an interior space (e.g., a hollow channel or cavity 222) of a preform 224 of a low(er) melting point material 226. The wire 220 and the preform 224 define or make up a precursor material arrangement. The process may be carried out using a fiber drawing apparatus 240, part of which is shown in FIG. 2A, having a heater or heating region 242. Heating may be carried out to at least the melting point of the material 226 of the preform 224. As the preform 224 and the wire 220 are heated in the heating region 242, the preform 224 melts or turns into a molten state. Once the wire 220 makes contact with the melt of the preform 224 (and therefore also the material 226) in the heating region 242, the preform 224 itself can drag the wire 220 down and may together be drawn into a fiber (or fiber-shaped structure) 230, thus, ensuring an intimate contact between the wire 220 and the cladding 232 made of the second material 226, as illustrated in FIG. 2A by a longitudinal section of the drawn fiber 230, shown enlarged in a cross-sectional view. The wire 220 defines a core 234 of the fiber 230. The interface 236 defined by the core 234 (i.e., the wire 220) and the cladding 232 (i.e., the material 226) is sharp and well-defined.

FIG. 2B to 2D show cross-sectional views of successful incorporation of different high melting point materials into fibers using the convergence method of various embodiments.

FIG. 2B shows an optical microscope image of a cross-section of a resulting fiber 230b with a silica core 234b and a polycarbonate (PC) cladding 232b, FIG. 2C shows a scanning electron microscope (SEM) image of a cross-section of an obtained fiber 230c with a copper core 234c and a polycarbonate (PC) cladding 232c, while FIG. 2D shows a scanning electron microscope (SEM) image of a cross-section of an obtained fiber 230d with a nickel chromium alloy core 234d and a polycarbonate (PC) cladding 232d.

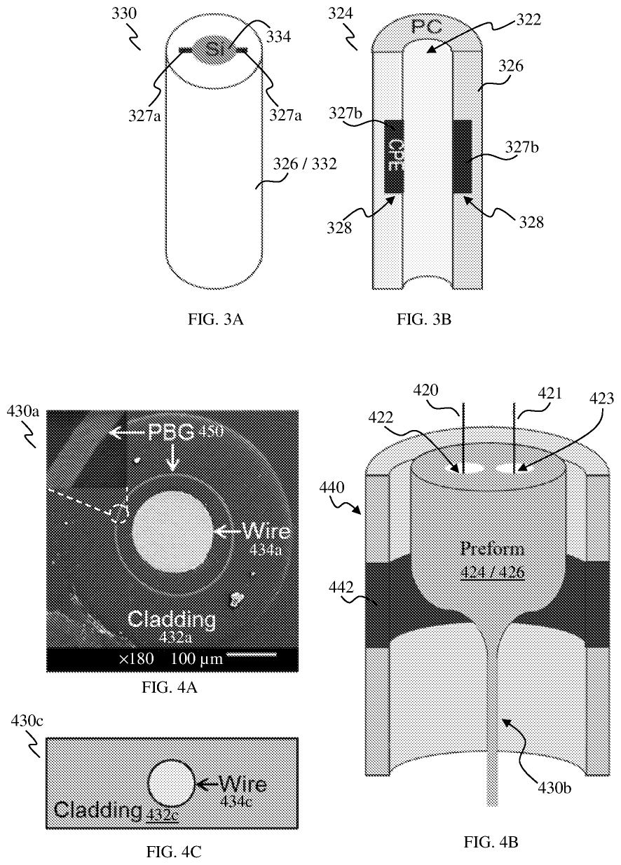

A more complex geometry may be achieved with the convergence method, including but not limited to the examples described below. FIG. 3A shows a schematic diagram illustrating a photodetector fiber 330 that may be fabricated using the convergence method. The fiber 330 may have a core 334 of semiconductor silicon (Si) and electrodes 327a made of a conductive material, e.g., conductive polyethylene (CPE), in (electrical) contact with the core 334. The cladding 332 is made of polycarbonate (PC) 326. FIG. 3B shows a schematic cross-sectional view of a longitudinal section of a hosting preform 324 for fabricating the fiber 330. The preform is made of PC 326. Two grooves 328 may be machined into the cylindrical preform 324 and filled with CPE 327b for defining the electrodes 327a. During the thermal drawing process to form the fiber 330, PC 326 and CPE 327b melt or are heated to a molten state. PC 326 has a melting point of about 140° C. and CPE 327b has a melting point that is close to that of PC 326. It should be appreciated that the melting points for the cladding material and the conductive material are at least substantially similar.

To form the fiber 330, during the thermal drawing process, a semiconductor wire such as silicon (Si), which eventually defines the core 334, may be fed into the preform 324, e.g., into the cavity 322. The resulting fiber 330 has a well-defined structure with the silicon wire/core 334 located in the center and two electrodes 327a on each side as shown in FIG. 3A. The contact of the silicon wire/core 334 and the electrodes 327a are intimate.

The convergence method may enable the claddings of the resulting fiber-shaped structures to have different structures or geometries, including complicated structures.

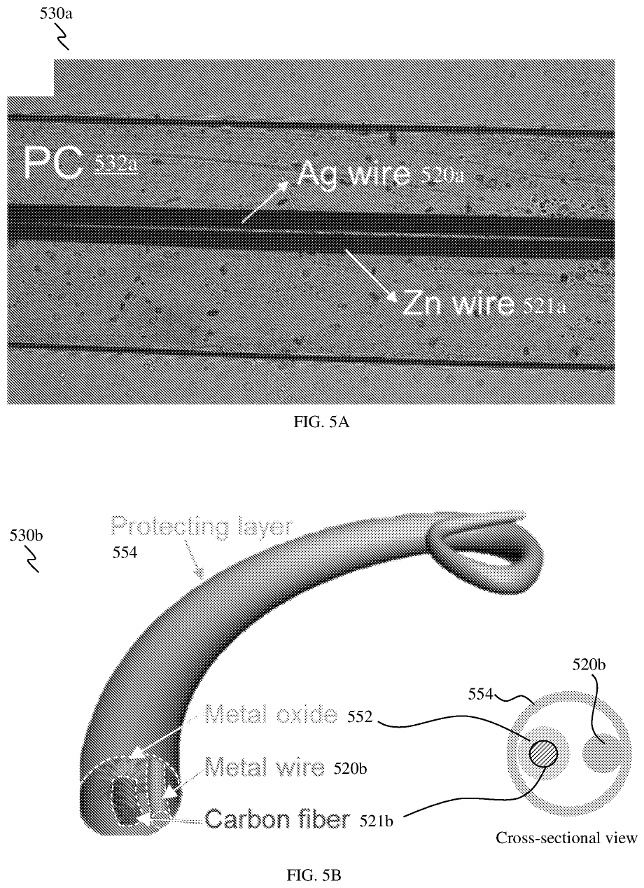

FIGS. 4A to 4C show examples of fibers of different structures that may be fabricated using the convergence method, illustrating respectively convergence of a photonic band gap fiber, use of multiple wires, and a different fiber shape in the form of a rectangle.

As a non-limiting example, referring to FIG. 4A, a photonic band gap (PBG) structure 450 may be provided to also act as the cladding or be formed as part of the cladding 432a. A pre-designed preform (not shown) with the PBG structure 450 may be used, and through the convergence method, a copper wire may be incorporated, resulting in the fiber 430a with a copper core 434a as shown in cross-sectional view in FIG. 4A.

The number of wires fed into the preform, or provided with the preform, is not limited to one (single) wire. For example, to achieve in-fiber semiconductor devices, different types of semiconductors and metals may be needed. Using the convergence method, multiple wires (of same or different materials) may be incorporated into the preform, e.g., simultaneously. FIG. 4B shows a schematic view illustrating a thermal drawing process with two wires 420, 421. The wires 420, 421 may be of the same material, although it should be appreciated that they may also be of different materials having different melting points. Further, while two wires 420, 421 are shown in FIG. 4A, it should be appreciated that the number of wires may be more than two, for example, three, four, five or any higher number.

The wires 420, 421 of high(er) melting point materials may be fed into respective interior spaces (e.g., hollow channels or cavities 422, 423) of a preform 424 of a low(er) melting point material 426. However, it should be appreciated that the wires 420, 421 may, in various embodiments, be provided into one (same) cavity of the preform 424. The wires 420, 421 and the preform 424 define or make up a precursor material arrangement. The thermal drawing process may be carried out using a fiber drawing apparatus 440, part of which is shown in FIG. 4B, having a heater or heating region 442. Heating may be carried out to at least the melting point of the material 426 of the preform 424. As the preform 424 and the wires 420, 421 are heated in the heating region 442, the preform 424 melts or turns into a molten state, and the material 426 and the wires 420, 421 may be drawn to form a fiber (or fiber-shaped structure) 430b. While not shown, there is intimate contact between the respective wires 420, 421 with the cladding of material 426 of the fiber 430b. The interface defined between the wire 420 and the cladding material 426, and the interface defined between the wire 421 and the cladding material 426 are sharp and well-defined. Each of the wires 420, 421 in the fiber 430b may define a core (region).

As a further non-limiting example, there is no limitation in terms of the shape, configuration or geometry of the resulting fiber that is formed. For example, by using a rectangular preform, a rectangular multimaterial fiber 430c as shown in FIG. 4C may be fabricated. The fiber 430c has a core 434c surrounded by a rectangular cladding 432c.

The ability to integrate metal wires and/or carbon-based materials, for example, inside a fiber-shape structure may allow the fabrication of various devices, for example, including but not limited to fiber-shaped energy harvesting and storage devices, such as batteries and supercapacitors.

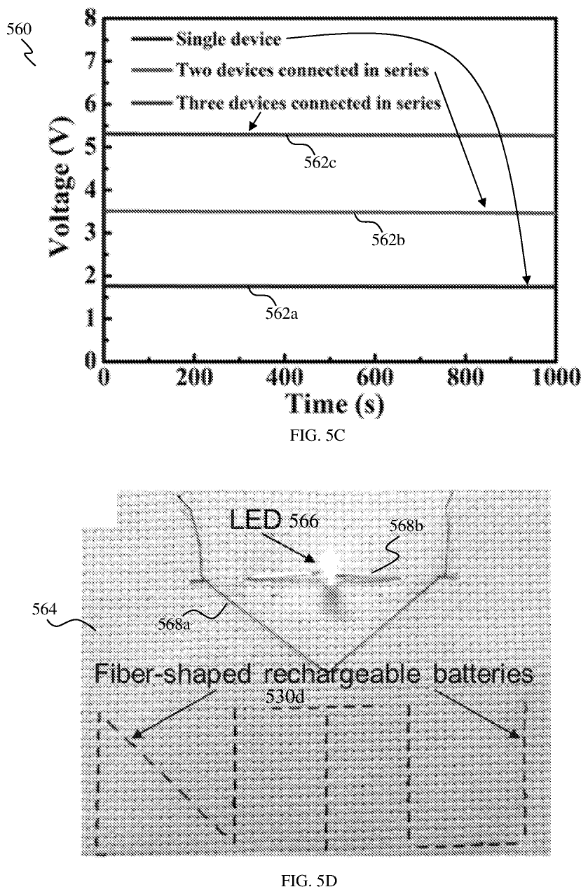

FIGS. 5A to 5D illustrate demonstration of using the method of various embodiments to fabricate in-fiber conductive wires. FIG. 5A shows an optical microscope image of a side view of a fiber 530a illustrating the integration with two different metal wires 520a, 521a. In one example embodiment, one wire 520a is silver (Ag), while the other wire 521a is zinc (Zn). The fiber 530a further includes a polycarbonate (PC) cladding 532a.

Further, the method may be capable of integrating carbon-related material(s) and/or metal oxide material(s) inside a fiber, as shown in FIG. 5B for a fiber-shaped battery 530b. The fiber 530b includes, in an internal portion of the fiber 530b, a metal wire 520b and a carbon fiber 521b with metal oxide 552 at least substantially surrounding the carbon fiber 521b. White dashed lines are illustrated to trace the boundaries of the various structures. Also shown in FIG. 5B is a schematic representation of the fiber-shaped battery 530b in cross-sectional view.

The carbon fiber 521b may serve as the matrix material for electrochemical deposition of metal oxide 552 thereon. The carbon fiber 521b itself can be used as an electrode, and it can reach higher performance with metal oxide 552 preferably deposited thereon. The metal oxide 552 may be fabricated on the carbon fiber 521b by electrochemical deposition before the fiber drawing. The metal oxide material 552 may be used as an electrode material. The metal oxide material 552 may have a higher energy density and specific surface area due to its unique morphology. The metal oxide material 552 may be in the form of fingers or spikes protruding from the carbon fiber 521b. As a non-limiting example, the fiber 530b may include a protecting layer 554 enclosing the metal wire 520b, the carbon fiber 521b and the metal oxide 552. The protecting layer 554 may be formed from the preform material and the layer 554 is preferably thin enough (e.g., <500 μm) to break after the scale-down process (i.e., the drawing process) and thus expose the metal wire 520b, the carbon fiber 521b and the metal oxide 552. Alternatively, the protecting layer 554 may be a layer that is formed or provided separately from the preform used (e.g., having a different material to the preform material), where the layer 554 may be etched out with certain etchants (e.g., etching solutions) during the fiber drawing process or after the drawing process, without the etchants etching the preform material.

Having fiber structures with two or multiple conductive wires inside a single fiber can lead to fiber-shaped devices, such as sensors, energy storage devices (e.g., batteries and supercapacitors), etc.

FIG. 5C shows the initial test of the fiber-shaped battery 530b of FIG. 5B, with a plot 560 of output voltage showing a voltage output of about 1.8 V that is at least substantially constant over the operation time of tens of minutes (see result 562a). It may be observed from FIG. 5C that the voltage output may be further increased by connecting more devices in series. Through the built-in metal wires as shown in FIG. 5B, multiple devices (batteries) may be electrically connected. Based on the fiber-shaped battery 530b (FIG. 5B), two fiber batteries may provide about 3.6 V output (see result 562b), while three fiber batteries may provide about 5.4 V output (see result 562c), as measured and shown in FIG. 5C.

The fabricated fiber-shaped devices may have high flexibility. As a result, the fibers may be provided on or woven into any flexible substrate, for example, a fabric. FIG. 5D shows a photograph illustrating demonstration of a wearable fabric 564 with fiber-shaped rechargeable batteries 530d (based on the fiber-shaped battery 530b of FIG. 5B) woven into the word “NTU” for lighting up an LED (light emitting device) 566. The batteries 530d may be connected in series using the built-in metal wires inside the fiber-shaped batteries 530d to power energy-consumption devices, such as lighting an LED 566. Conductive paths 568a, 568b, e.g., wires, may be provided to electrically couple the batteries 530d to the LED 566.

The methods of various embodiments may also be employed to fabricate polymer electrodes and semiconductor core in one single fiber. Inorganic semiconductors (e.g., silicon (Si), germanium (Ge), etc.) are widely used in commercial electronics. However, their poor flexibility limits the application in wearable devices. Based on the convergence method of various embodiments, inorganic semiconductors may be successfully incorporated into polymer-based fibers and improve the flexibility. For example, photodetectors may be fabricated in a large scale at low cost.

FIG. 6A shows a schematic diagram illustrating thermal drawing of a fiber (e.g., photodetector fiber) using a preform design with a (complex) geometry having two polymer electrodes (e.g., conductive polyethylene (CPE) or conductive polycarbonate (CPC)) and a semiconductor wire (e.g., doped Si or doped Ge).

In a thermal drawing process, a wire 620 of a high(er) melting point material may be fed into an interior space (e.g., a cavity 622) of a preform 624 of a low(er) melting point material 626. The wire 620 and the preform 624 define or make up a precursor material arrangement. The preform 624 includes conductive material 627a which may act as electrodes. The conductive material 627a may be provided on opposite sides of the cavity 622. As a non-limiting example, the preform 624 may have a rectangular shape.

The process may be carried out using a fiber drawing apparatus 640, part of which is shown in FIG. 6A, having a heater or heating region 642. Heating may be carried out to at least the melting point of the material 626 of the preform 624. The conductive material 627a may have a melting point that is close to or at least substantially similar to that of the material 626. As the preform 624 with the conductive material 627a, and the wire 620 are heated in the heating region 642, the material 626 and the conductive material 627a melt or turn into a molten state and the material 626, the conductive material 627a, and the wire 620 may be drawn into a fiber (or fiber-shaped structure) 630a.

As illustrated in FIG. 6A by a longitudinal section of the drawn fiber 630a, shown enlarged in a cross-sectional view, the fiber 630a may include a core 634, defined by the wire 620, that is in contact with electrodes 627b formed from the conductive material 627a, and a cladding 632 of the material 626 of the preform 624. There is intimate contact between the core 634 with the electrodes 627b and the cladding 632. The respective interfaces defined between the core 634 and the electrodes 627b, and between the core 634 and the cladding 632 are sharp and well-defined.

FIG. 6B shows an optical image of a used preform 624b and the resulting fiber 630b. As may be observed, the fiber 630b is flexible and may be looped around.

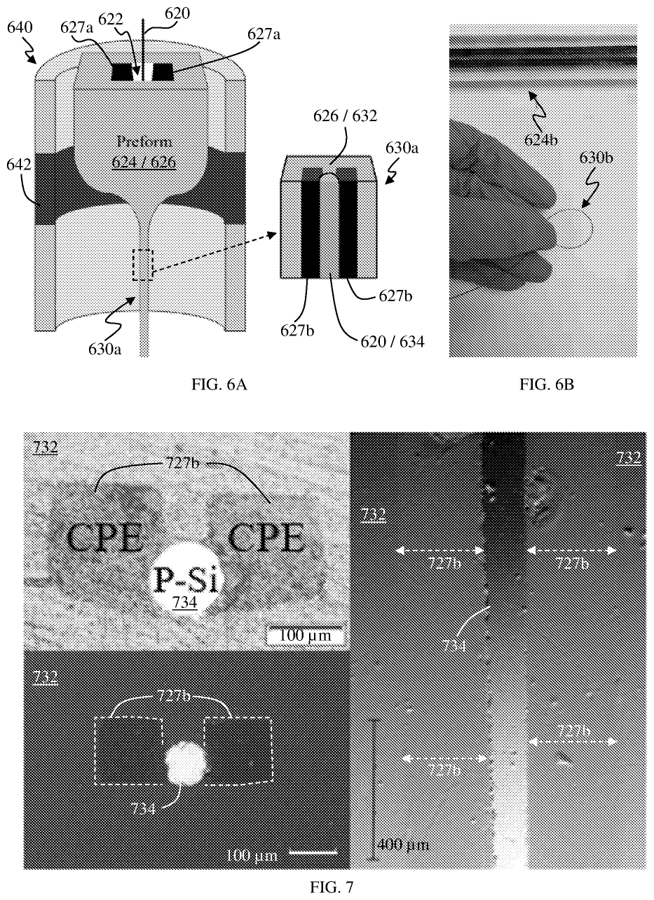

FIG. 7 shows an optical microscope image (top view of fiber) and two scanning electron microscope (SEM) images (top and side views of fiber) of a fiber fabricated based on the thermal drawing process of FIG. 6A. As may be observed from the images, the resulting fiber shows good contact between the polymer electrodes (CPE) 727b and the semiconductor (p-doped silicon) core 734, with a cladding 732 surrounding the electrodes 727b and the core 734. In the SEM image of the top view of the fiber, for clarity, two dashed boxes are overlaid to trace the boundaries of the electrodes 727b. The double-headed dashed arrows in the SEM image of the side view of the fiber represent the width of the electrodes 727b.

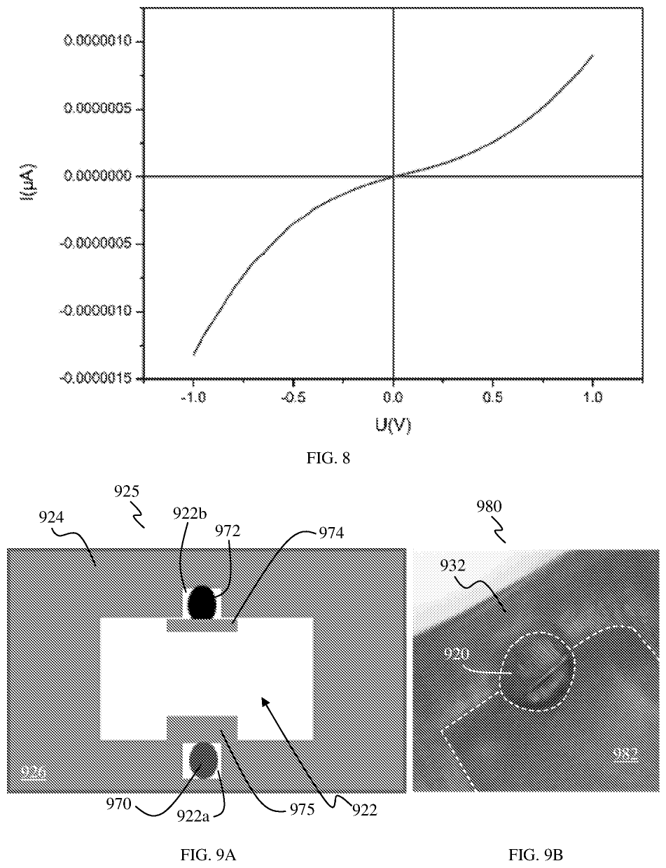

FIG. 8 shows a current-voltage plot corresponding to the fiber of FIG. 7. The Schottky contact confirms the optimized electrical contact between the polymer electrodes 727b and the semiconductor core 734.

The methods of various embodiments may also be employed to fabricate fibers with complex core structures. The core materials are not limited to semiconductors, but any materials with a melting point that is higher than the thermal drawing temperature or the melting point of the material of the preform may be used for the wire or core of the fabricated fiber. Also, materials with other shapes (rather than wires) for the core may be incorporated into the fiber.

With the convergence method of various embodiments, more than one type of materials may be incorporated into the resulting fibre.

FIG. 9A shows a schematic view of a precursor material arrangement 925 for fiber-based battery. The precursor material arrangement 925 includes a preform 924 of a rectangular shape although other shapes may be possible. The preform 924 includes a material 926, for example, a low(er) melting point material. As a non-limiting example, the material 926 may be polymer for forming a polymer cladding. A hollow channel or cavity 922 may be defined in the preform 924. The cavity 922 may be of a rectangular shape although other shapes may be possible. Two further hollow channels (or cavities or chambers) 922a, 922b may be defined in the preform 924, and may be used for incorporation of two electrodes. For forming a fiber-based battery, an electrolyte may be filled in before the drawing process, into the cavity 922, and/or after the drawing process, into the hollow channel that is formed from the cavity 922.

The precursor material arrangement 925 may further include a metal electrode (or metal wire) 970 in the chamber 922a, and a carbon fiber 972 with porous silver (Ag) deposited thereon arranged in the other chamber 922b opposite to the chamber 922a, where the metal electrode 970 and the carbon fiber 972 may be fed into the preform 924 during the thermal drawing process. The carbon fiber with Ag 972 may also act as an electrode. The precursor material arrangement 925 may further include respective sacrificial layers 974, 975 for supporting the metal electrode 970 and the carbon fiber 972 in the respective chambers 922a, 922b, and respectively holding or fixing the metal electrode 970 and the carbon fiber 972 during thermal drawing. During the thermal drawing process, eventually, the sacrificial layers 974, 975 break (or disintegrate) and detach with the scale-down process when forming the resulting fiber-shaped structure, thereby exposing the metal electrode 970 and the carbon fiber 972 to the resulting hollow channel corresponding to the cavity 922. This allows the metal electrode 970 and the carbon fiber 972 to make contact with the electrolyte that is filled into the cavity 922 or the hollow channel. Alternatively, thicker sacrificial layers may be used for layers 974, 975 to provide a better support, if required, and, which may subsequently be etched away.

Materials for the sacrificial layers 974, 975 may be chosen on consideration of the combination of materials of the material (e.g., polymer) 926 of the preform 924 (which may eventually form the cladding of the resulting fiber), the metal electrode 970 and/or the carbon fiber 972, and the sacrificial layers 974, 975. Materials to be used for the sacrificial layers 974, 975 may have one or more of the following properties: (i) the material is a thermoplastic, (ii) the material has a glass transition temperature similar to that of the material 926, (iii) the material can be etched out if the sacrificial layer is a thicker layer (e.g., >500 μm). As a non-limiting example, polycarbonate may be used as the sacrificial layer in a preform that is made from polycarbonate, which may require the sacrificial layer to be thin (e.g., <500 μm). As a further non-limiting example, polyvinylidene fluoride (PVDF) may be used as the sacrificial layer in a cyclic olefin copolymer (COC) preform. As PVDF can be etched out, it can be used to form a thicker sacrificial layer.

FIG. 9B shows an optical microscope image of part of a fabricated fiber-based battery 980. The battery 980 may include a metal wire 920 (e.g., corresponding to metal electrode 970 of FIG. 9A) that is of a high(er) melting point material. Approximately half of the metal wire 920 may be incorporated into the cladding 932 or fiber wall made of the material 926, with the other half of the metal wire 920 being exposed into the hollow channel (or cavity) 982 corresponding to the cavity 922 to make contact with an electrolyte that may already be filled into or to be filled into the channel 982. For clarity, dashed lines are overlaid to trace the boundaries of the metal wire 920 and the wall bordering the hollow channel 982.

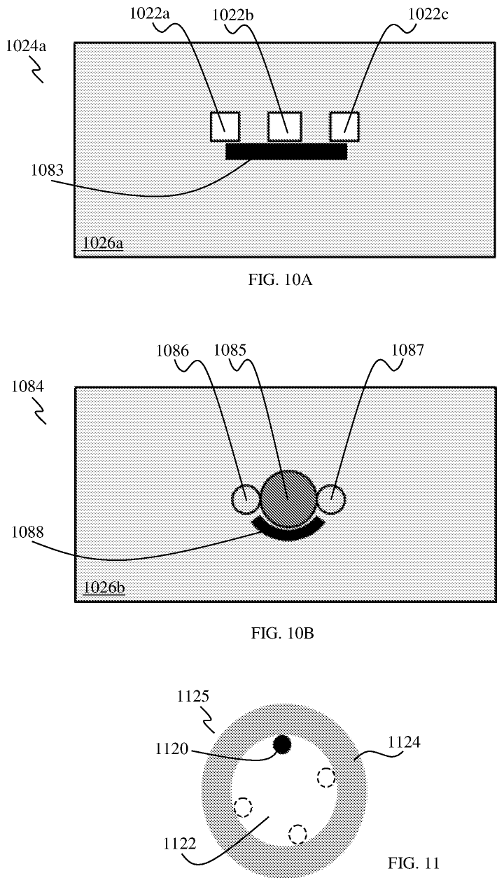

Using the convergence method, the limitations of materials in thermal drawing may be largely addressed or removed. With multiple materials converging together, devices such as fiber-based FET may be realised using the non-limiting example structures shown in FIGS. 10A and 10B.

FIGS. 10A and 10B show schematic cross-sectional views respectively of a preform for fiber-based FET (field effect transistor) and a fiber-based FET fabricated using the preform of FIG. 10A.

Referring to FIG. 10A, the preform 1024a may be of a rectangular shape although other shapes may be possible. The preform 1024a includes a material 1026a, for example, a low(er) melting point material. The preform 1024a may further include three hollow channels or cavitites 1022a, 1022b, 1022c, and a gate layer 1083.

Referring to FIG. 10B, the FET 1084 may be of a rectangular shape, similar to that of the preform 1024a, although other shapes may be possible. The FET 1084 includes a material 1026b, corresponding to the material 1026a, that defines a cladding. The FET 1084 may further include a semiconductor region 1085, with a source region 1086 and a drain region 1087 on the sides (e.g., opposite sides) of the semiconductor region 1085, where respective materials of the semiconductor region 1085, the source region 1086 and the drain region 1087 may be fed into the respective cavities 1022b, 1022a, 1022c during the thermal drawing process. The FET 1084 may further include a gate 1088 that is formed from the gate layer 1083. As shown in FIG. 10A, the gate layer 1083 may be flat before the thermal drawing process. When or after being subjected to the thermal drawing process, the hollow channels 1022a, 1022b, 1022c converge with the fed-in materials for the source region 1086, the semiconductor region 1085 and the drain region 1087. This convergence process causes a change in the shape of the cladding, and with this change, the gate 1088 that is formed from the gate layer 1083 may become curved and the gate 1088 may maintain the distance (with corresponding scale-down) to the interface of the cladding and the fed-in materials. As shown in FIGS. 10A and 10B, with the convergence method, the source region 1086, the semiconductor region 1085 and the drain region 1087 may have circular shapes compared to the square shapes of the corresponding cavities 1022a, 1022b, 1022c.

As non-limiting examples, highly doped silicon (Si) or germanium (Ge) may be used as the material for the semiconductor region 1085 located in the center. For the source region 1086 and the drain region 1087, metal wires may be used. Carbon-doped polycarbonate may be used as the material for the gate 1088. For the cladding material 1026b, polycarbonate may be used.

In the context of various embodiments, it should be appreciated that the wire (or second material or core material) (e.g., 220, FIG. 2A; 420, 421, FIG. 4B) may be in contact with the preform prior to the thermal drawing process. The wire may be provided at any location at the inner rim of the preform before the thermal drawing process. Even if the wire is not parallel with the preform axially (i.e., not parallel with the longitudinal axis of the preform), the wire is likely to become parallel with the fiber-shaped structure axially after thermal drawing.

FIG. 11 shows a schematic cross-sectional view of a precursor material arrangement 1125, according to various embodiments. The precursor material arrangement 1125 may include a cylindrical preform 1124 (although preforms of other shapes may also be used) with a hollow channel 1122 defined therein that may be used for the convergence method. The precursor material arrangement 1125 may further include a wire 1120 which is in contact with the preform 1124. As shown in FIG. 11, the wire 1120 contacts the inner rim or surface of the preform 1124. As non-limiting examples, the three dotted circles are shown in FIG. 11 to represent some of the different potential locations for a wire. It should be appreciated that one or more wires may be provided in the precursor material arrangement 1125.

In various embodiments, precursor material arrangements, and the resulting fiber-shaped structures, may include two or more wires being arranged in a concentric manner. Using two wires as a non-limiting example, in the precursor material arrangements, one wire may be located at an inner concentric path, while another wire may be located at an outer concentric path. FIGS. 12A and 12B show non-limiting examples illustrating such concentric arrangements for physically supporting the inner wire.

FIG. 12A shows a precursor material arrangement 1225a having a preform 1224a of a first material 1226a with a cavity 1222a defined therein. The precursor material arrangement 1225a further includes two wires 1220a, 1221a which are connected together axially before the thermal drawing process, and provided or fed as one (single) object during the thermal drawing process. One wire 1220a may be provided at an inner concentric path, traced by the dashed circle 1290a, while the other wire 1221a may be provided at an outer concentric path, traced by the dashed circle 1291a. Through the convergence method, the thermal drawing process produces a fiber-shaped structure 1230a having a concentric structure, with the wire 1220a located at about the centre of the fiber-shaped structure 1230a, the wire 1221a located in between and in contact with the wire 1220a and the material (i.e., cladding) 1226a, with a cavity or unfilled space 1223a defined in the fiber-shaped structure 1230a.

FIG. 12B shows a precursor material arrangement 1225b having a preform 1224b of a first material 1226b. Much of the preform 1224b is filled with the material 1226b except for small cavities (not clearly shown in FIG. 12B) to accommodate wires 1220b, 1221b for the thermal drawing process. The wires 1220b, 122 lb of the precursor material arrangement 1225b are separate wires before the thermal drawing process, and provided or fed separately during the thermal drawing process. One wire 1220b may be provided at an inner concentric path, traced by the dashed circle 1290b, while the other wire 1221b may be provided at an outer concentric path, traced by the dashed circle 1291b. Through the convergence method, the thermal drawing process produces a fiber-shaped structure 1230b having a concentric structure, with the wire 1220b located at about the centre of the fiber-shaped structure 1230b, and the wire 1221b located in contact with the wire 1220a. The fiber-shaped structure 1230b is free of unfilled space or cavity.

It should be appreciated that suitable modifications may be made to the structures shown in FIGS. 12A and 12B, including one or more of (i) two or more wires being arranged at the inner concentric path, (ii) two or more wires being arranged at the outer concentric path, (iii) more than two concentric paths, with one or more wires being arranged at each concentric path.

In various embodiments of the convergence method, in addition to or alternatively to the wire (e.g., 220, FIG. 2A; 420, 421, FIG. 4B), particles (e.g., glass, semiconductor, metal, etc.) may be provided during the thermal drawing process to be incorporated into the drawn fiber to realise different structures and/or functions. A combination of wire(s) and particle(s) may be provided for drawing with a preform into a fiber-shaped structure.

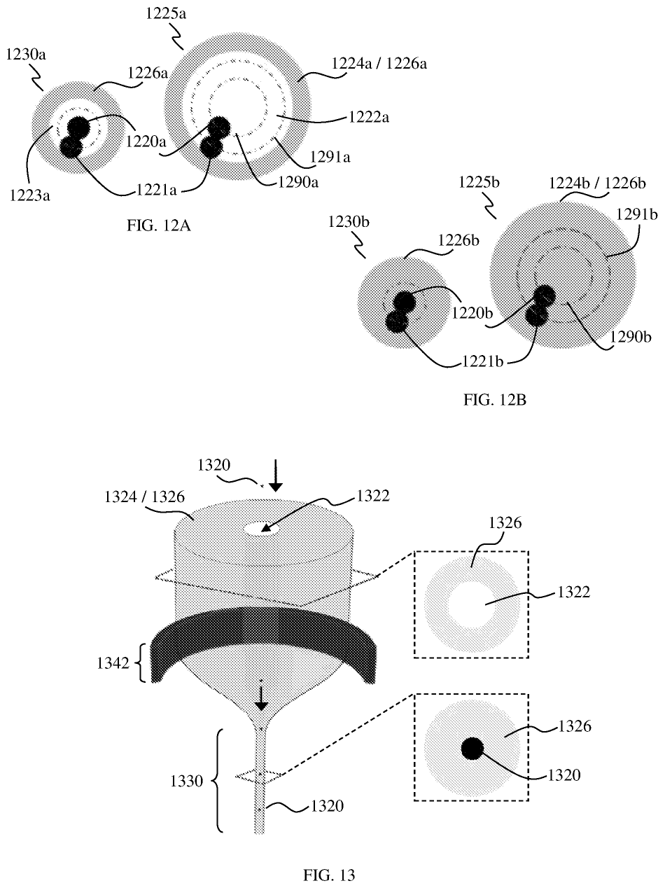

Using the convergence method, particles of a high(er) melting point material may be fed into an interior space of a preform. The particles may be spherical or circular or of any other suitable shapes. Referring to FIG. 13 illustrating thermal drawing with incorporation of particles 1320, an interior space (e.g., hollow channel or cavity 1322) of the preform 1324 of a first material 1326 provides the space for allocating the particles 1320 into, where the particles 1320 may be fed into the space 1322 (as represented by the directional arrows). The particles 1322 may be fed at a defined time interval to create corresponding distance between each particle in the resulting fiber 1330. The particles 1320 and the preform 1324 define or make up a precursor material arrangement. The thermal drawing process may be carried out using a fiber drawing apparatus having a heater or heating region 1342. As the particles 1320 are fed in, the particles 1320 converge with the material 1326 after thermal drawing and constructs an intact fiber-shaped structure 1330 with ordered particle distribution axially, as shown in FIG. 13.

Heating may be carried out to at least the melting point of the material 1326 of the preform 1324. As the preform 1324 and the particles 1320 are heated in the heating region 1342, the preform 1324 melts or turns into a molten state, and the material 1326 and the particles 1320 may be drawn to form the fiber (or fiber-shaped structure) 1330. There is intimate contact between the particles 1320 and the material 1326 of the fiber 1330. The interface defined between each particle 1320 and the material 1326 is sharp and well-defined.

A fiber may be fabricated with a plurality of particles provided along one or more cross-sectional planes of the fiber, for example, longitudinally along a length direction of the fiber and/or tranversely along a width direction of the fiber. Further, particles arranged in an order along one or more radial directions may also be realised. Such various structures may have potential applications in electronics, sensors, energy storage,etc.

It should be appreciated that description in the context of one embodiment, for example, in relation to a particular figure, may correspondingly be applicable to other embodiments. For example, individual characteristics of two or more embodiments may be combined to provide a method and a resulting fiber-shaped structure having combined characteristics of these embodiments.

As described above, various embodiments may provide convergence methods for fabricating multi-material multi-functional fibers, and the resulting fibers fabricated by such methods.

The techniques disclosed herein may be suitable for various applications, including but not limited to, (i) wearable electronics, including consumer electronics, healthcare, etc., (ii) multiple signals sensing and monitoring, (iii) energy harvesting and storage, such as fiber-shaped batteries and supercapacitors, (iv) military applications.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method of forming a fiber-shaped structure, the method comprising:
subjecting a precursor material arrangement to a thermal drawing process to form the fiber-shaped structure, the precursor material arrangement comprising:
a preform of a first material having a first melting point; and
a second material in an interior space of the preform, the second material having a second melting point that is higher than the first melting point,
wherein the thermal drawing process comprises subjecting the preform and the second material to a heating process to heat the preform to a molten state for forming the fiber-shaped structure, wherein the second material that is heated remains in a solid state, and
wherein the fiber-shaped structure that is formed comprises the first material and the second material.

2. The method as claimed in claim 1, further comprising feeding the second material into the interior space of the preform during the thermal drawing process.

3. The method as claimed in claim 1, wherein the second material of the precursor material arrangement is in contact with the preform.

4. The method as claimed in claim 1, wherein the second material of the precursor material arrangement is in an elongate shape.

5. The method as claimed in claim 1, wherein the second material of the precursor material arrangement is in a particulate form.

6. The method as claimed in claim 1, wherein the second material comprises at least one of a metal, an alloy, a semiconductor, a ceramic, a carbon-based material or a glass.

7. The method as claimed in claim 1, wherein the first material comprises at least one of a glass or a thermoplastic polymer.

8. The method as claimed in claim 1, wherein a difference between the second melting point and the first melting point is in a range of between about 50° C. and about 5000° C.

9. The method as claimed in claim 1,
wherein the preform further comprises a conductive material,
wherein the conductive material is subjected to the heating process for forming the fiber-shaped structure, and
wherein the fiber-shaped structure that is formed further comprises the conductive material.

10. The method as claimed in claim 1,
wherein the preform further comprises a photonic bandgap structure, and
wherein the photonic bandgap structure is subjected to the heating process for forming the fiber-shaped structure, and
wherein the fiber-shaped structure that is formed further comprises the photonic bandgap structure.

11. The method as claimed in claim 1, wherein the second material comprises a conductive material.

12. The method as claimed in claim 1,
wherein the precursor material arrangement further comprises a third material in the interior space of the preform, the third material having a third melting point that is higher than the first melting point,
wherein the thermal drawing process further comprises subjecting the third material to the heating process for forming the fiber-shaped structure, wherein the third material that is heated remains in a solid state, and
wherein the fiber-shaped structure that is formed further comprises the third material.

13. The method as claimed in claim 12,
wherein the second melting point and the third melting point are at least substantially the same.

14. The method as claimed in claim 12,
wherein the second melting point and the third melting point are different melting points.

15. The method as claimed in claim 12, wherein the third material of the precursor material arrangement is in an elongate shape or in a particulate form.

16. A fiber-shaped structure obtained by the method as claimed in claim 1.

17. The fiber-shaped structure as claimed in claim 16, wherein the fiber-shaped structure comprises at least one of an optical device, an electrical device, or a mechanical device.

18. The fiber-shaped structure as claimed in claim 17, wherein the fiber-shaped structure comprises the electrical device, the electrical device further comprising an electrolyte.

19. The fiber-shaped structure as claimed in claim 16, wherein the fiber-shaped structure is flexible.

20. A device comprising the fiber-shaped structure as claimed in claim 16.
